(19) United States
(12) Patent Application Publication
(10) Pub. No.: US 2025/0239183 A1
(43) Pub. Date: Jul. 24, 2025

(54) INSERT CONNECTION SYSTEMS FOR PATIENT SIMULATORS

(71) Applicant: GAUMARD SCIENTIFIC COMPANY, INC., Miami, FL (US)

(72) Inventors: Victor FERNANDEZ, Miami, FL (US); Karina ZORNOZA, Miami, FL (US); Julio FERRER, Miami, FL (US)

(21) Appl. No.: 19/029,131

(22) Filed: Jan. 17, 2025

Related U.S. Application Data
(60) Provisional application No. 63/623,188, filed on Jan. 19, 2024.

(51) Int. Cl. G09B 23/34; G09B 23/30

(52) U.S. Cl. CPC G09B 23/34; G09B 23/303

(57) ABSTRACT

Insert connection systems for patient simulators and associated devices, systems, and methods are provided. In some instances, a patient simulator comprises: a simulated portion of a human body; and an insert configured to be selectively coupled to the simulated portion of the human body via an insert connection system, wherein one of the simulated portion of the human body or the insert includes a plurality of male connectors of the insert connection system and the other of the simulated portion of the human body or the insert includes a plurality of female connectors of the insertion connection system, wherein each male connector includes at least one pair of opposing arms and each female connector includes a projection and the at least one pair of opposing arms of the male connector is configured to releasably engage with the projection of the female connector.

### CROSS-REFERENCE TO RELATED APPLICATIONS

The present application claims priority to and the benefit of U.S. Provisional Patent Application No. 63/623, 188, filed Jan. 19, 2024, which is hereby incorporated by reference in its entirety for all applicable purposes.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. Pat. Nos. 11,756,451, 8,696,362, 8,016,598, 7,976,312, 7,976,313, U.S. patent application Ser. No. 11/952,669 (Publication No. 20090148822), U.S. Pat. Nos. 7,114,954, 6,758,676, 6,503,087, 6,527,558, 6,443,735, 6,193,519, and 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure describes insert connection systems for patient simulators. In this regard, the insert connection systems of the current disclosure can allow a single patient simulator to provide realistic simulation of a plurality of different medical scenarios associated with the same portion of the simulator by allowing rapid, but secure interchanging of inserts utilizing the associated connection systems. In some instances, a plurality of different inserts are provided that simulate different levels and/or types of trauma. Two or more inserts simulating various classification grades and/or different types of trauma may be provided and selectively interchanged using a connection system common to all the inserts. In this regard, while some of the examples provided herein are related to vaginal inserts, it is understood that the connection systems of the present disclosure may be used in a variety of other situations and areas of the patient simulator, including areas with variable and/or inconsistent skin profiles.

In some aspects, a patient simulator comprises: a simulated portion of a human body; and an insert configured to be selectively coupled to the simulated portion of the human body via an insert connection system, wherein one of the simulated portion of the human body or the insert includes a plurality of male connectors of the insert connection system and the other of the simulated portion of the human body or the insert includes a plurality of female connectors of the insertion connection system, wherein each male connector includes at least one pair of opposing arms and each female connector includes a projection and the at least one pair of opposing arms of the male connector is configured to releasably engage with the projection of the female connector. The at least one pair of opposing arms may define an opening having an oval shape configured to mate with an outer profile of the projection of each female connector. The at least one pair of opposing arms may be configured to expand around the projection of each female connector as the male connector is inserted into the female connector. Each male connector may include at least two pairs of opposing arms and each female connector may include at least two projections. The male connector may be formed of a first material and the female connector may be formed of a second material different than the first material. The first material may be more flexible than the second material. The insert includes the plurality of male connectors in some instances. The plurality of male connectors may be attached to the insert by engagement of one or more layers of the insert with an anchor portion of each of the plurality of male connectors. The anchor portion may include a plurality of openings through which material of the one or more layers of the insert extends through. The patient simulator may further comprise one or more replacement inserts. Each of the one or more replacement inserts may be configured to be selectively coupled to the simulated portion of the human body via the insert connection system. The one or more replacement inserts may simulate a different level and/or type of trauma than the insert. The insert may comprise a simulated skin layer. The insert may comprise a vaginal insert.

In some aspects, an insert connection system for patient simulators comprises a plurality of male connectors configured to be coupled to an insert; and a plurality of female connectors configured to be coupled to a patient simulator; wherein each male connector of the plurality of male connectors includes at least one pair of opposing arms; each female connector of the plurality of female connectors includes a projection; and the at least one pair of opposing arms of each male connector of plurality of male connectors is configured to releasably engage with the projection of each female connector of the plurality of female connectors. The at least one pair of opposing arms may be configured to expand around the projection of the female connector as the male connector is inserted into the female connector. The at least one pair of opposing arms may define an opening having an oval shape configured to mate with an outer profile of the projection of each female connector. Each male connector may include at least two pairs of opposing arms and each female connector may include at least two projections. The male connector may be formed of a first material and the female connector may be formed of a second material different than the first material. The first material may be more flexible than the second material. The plurality of male connectors may include an anchor portion having a plurality of openings configured to engage with material of one or more layers of the insert.

In some aspects, a method comprises coupling a first insert to a simulated portion of a human body using an insert connection system by engaging a plurality of male connectors coupled to the insert with a plurality of female connectors coupled to the simulated portion of the human body, wherein each male connector includes at least one pair of opposing arms and each female connector includes a projection; decoupling the first insert from the simulated portion of a human body by disengaging the plurality of male connectors from the plurality of female connectors; and coupling a second insert to the simulated portion of the human body using the insert connection system by engaging a plurality of male connectors coupled to the second insert with the plurality of female connectors coupled to the simulated portion of the human body. The second insert may simulate a different level and/or type of trauma than the first insert. The at least one pair of opposing arms may define an opening having an oval shape configured to mate with an outer profile of the projection of each female connector. The at least one pair of opposing arms may be configured to expand around the projection of each female connector as the male connector is inserted into the female connector. Each male connector may include at least two pairs of opposing arms and each female connector may include at least two projections. The male connector may be formed of a first material and the female connector may be formed of a second material different than the first material. The first material may be more flexible than the second material. The plurality of male connectors may be attached to the insert by engagement of one or more layers of the insert with an anchor portion of each of the plurality of male connectors. The anchor portion may include a plurality of openings through which material of the one or more layers of the insert extends through. The method may further comprise selecting the second insert from a plurality of replacement inserts, each of the plurality of replacement inserts configured to be selectively coupled to the simulated portion of the human body via the insert connection system. Each of plurality of replacement inserts may simulate a different level and/or type of trauma. The insert may comprise a simulated skin layer. The insert may comprise a vaginal insert.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator including a simulated torso, a simulated head, a simulated neck, a simulated right arm, a simulated left arm, a simulated right leg, and a simulated left leg, including at least one insert using an insert connection system according to one or more aspects of the present disclosure.

FIG. 2 is a front view of the patient simulator 100 showing a vaginal insert 230 using an insert connection system, according to one or more aspects of the present disclosure.

FIG. 3 is a perspective view of the vaginal insert 230 showing the male portion of the insert connection system, according to one or more aspects of the present disclosure.

FIG. 4 is a front view of a portion of the torso 115 of the patient simulator 100 showing the female portion of the insert connection system, according to one or more aspects of the present disclosure.

FIG. 5 is a perspective, phantom view of the male portion of the insert connection system engaged with the female portion of the insert connection system, according to one or more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

One of the aims of healthcare simulation is to establish a teaching environment that closely mimics key clinical cases in a reproducible manner. The introduction of high fidelity tetherless simulators, such as those available from Gaumard Scientific Company, Inc., over the past few years has proven to be a significant advance in creating realistic teaching environments. The present disclosure is directed to a patient simulator that expands the functionality of the simulators by increasing the realism of the look, feel, and functionality of the simulators that can be used to train medical personnel in a variety of clinical situations. The patient simulator disclosed herein offers a training platform on which medical scenarios can be performed for the development of medical treatment skills and the advancement of patient safety. Accordingly, the user's medical treatment skills can be obtained and/or improved in a simulated environment without endangering a live patient. Moreover, the patient simulator allows for multiple users to simultaneously work with the patient simulator during a particular medical scenario, thereby facilitating team training and assessment in a realistic, team-based environment.

In several aspects, the patient simulator includes features designed to enhance the educational experience. For example, in several aspects, the system includes a processing module to simulate different medical and/or surgical scenarios during operation of the patient simulator. In several aspects, the system includes a camera system that allows visualization of the procedure for real-time video and log capture for debriefing purposes. In several aspects, the patient simulator is provided with a workbook of medical scenarios that are pre-programmed in an interactive software package, thereby providing a platform on which medical scenarios can be performed for the development of medical treatment skills and general patient safety. Thus, the patient simulators disclosed herein provide a system that is readily expandable and updatable without large expense and that enables users to learn comprehensive medical and surgical skills through “hands-on” training, without sacrificing the experience gained by users in using standard surgical instruments in a simulated patient treatment situation.

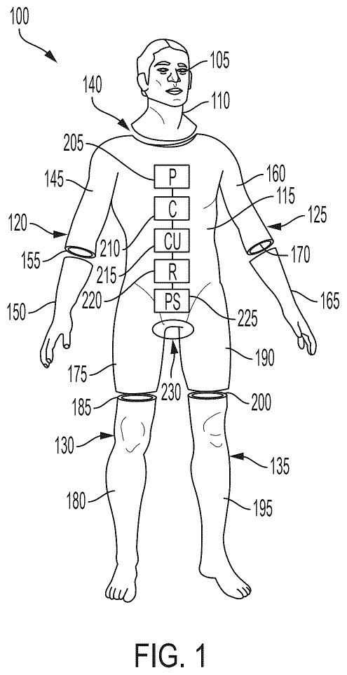

Referring to FIG. 1, in some aspects, a patient simulator is generally referred to by the reference numeral 100 and includes a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 may be coupled to the simulated neck 110. For example, the simulated head 105 may be integrally formed with and/or detachably coupled to the simulated neck 110. The patient simulator 100 may further include a head coupling 140. The simulated neck 110 may be adapted to be detachably coupled to the simulated torso 115 via the head coupling 140. In some aspects, the simulated right arm 120 includes a simulated upper right arm 145 (or “extremity”) and a simulated lower right arm 150 (or “extremity”). The simulated upper right arm 145 may be coupled to the simulated torso 115. For example, the simulated upper right arm 145 may be integrally formed with and/or detachably coupled to the simulated torso 115. The simulated right arm 120 may further include a right arm coupling 155 (or “extremity coupling”). The simulated lower right arm 150 may be detachably coupled to the simulated upper right arm 145 via the right arm coupling 155. Similarly, the simulated left arm 125 may include a simulated upper left arm 160 (or “extremity”) and a simulated lower left arm 165 (or “extremity”). The simulated upper left arm 160 may be coupled to the simulated torso 115. For example, the simulated upper left arm 160 may be integrally formed with and/or detachably coupled to the simulated torso 115. The simulated left arm 125 may further include a left arm coupling 170 (or “extremity coupling”). The simulated lower left arm 165 may be detachably coupled to the simulated upper left arm 160 via the left arm coupling 170.

The simulated right leg 130 may include a simulated upper right leg 175 (or “extremity”) and a simulated lower right leg 180 (or “extremity”). The simulated upper right leg 175 may be coupled to the simulated torso 115. For example, the simulated upper right leg 175 may be integrally formed with and/or detachably coupled to the simulated torso 115. The simulated right leg 130 may further include a right leg coupling 185 (or “extremity coupling”). The simulated lower right leg 180 may be detachably coupled to the simulated upper right leg 175 via the right leg coupling 185. Similarly, the simulated left leg 135 may include a simulated upper left leg 190 (or “extremity”) and a simulated lower left leg 195 (or “extremity”). The simulated upper left leg 190 may be coupled to the simulated torso 115. For example, the simulated upper left leg 190 may be integrally formed with and/or detachably coupled to the simulated torso 115. The simulated left leg 135 may further include a left leg coupling 200 (or “extremity coupling”). The simulated lower left leg 195 may be detachably coupled to the simulated upper left leg 190 via the left leg coupling 200.

In some instances, the simulated torso 115 may be divided into a simulated upper torso and a simulated lower torso. In such instances, the simulated upper right arm 145 and the simulated upper left arm 160 may be coupled to the simulated upper torso. For example, the simulated upper right arm 145 and the simulated upper left arm 160 may be integrally formed with and/or detachably coupled to the simulated upper torso. The simulated upper right leg 175 and the simulated upper left leg 190 may be coupled to the simulated lower torso. For example, the simulated upper right leg 175 and the simulated upper left leg 190 may be integrally formed with and/or detachably coupled to the simulated lower torso. The simulated torso 115 may further includes a torso coupling via which the simulated upper torso may be detachably coupled to the simulated lower torso.

The simulated torso 115 (as well as the simulated head 105, simulated neck 110, simulated right arm 120, simulated left arm 125, a simulated right leg 130, and/or simulated left leg 135) may contain one or more pump(s) 205, compressor(s) 210, control unit(s) 215, reservoir(s) 220, power source(s) 225, and/or other components. The pump(s) 205 may be adapted to supply hydraulic pressure to various features/components of the patient simulator 100. The features/components to which hydraulic pressure is supplied by the pump(s) 205 may be contained in the simulated torso 115, the simulated head 105, the simulated right arm 120, the simulated left arm 125, the simulated right leg 130, and/or the simulated left leg 135. In some instances, the pump(s) 205 may supply hydraulic pressure to one or more of the reservoir(s) 220. For example, the pump(s) 205 may cause fluid to be transferred into and/or out of one or more of the reservoir(s) 220. In this regard, the reservoir(s) 220 may contain fluid and/or gas.

The compressor(s) 210 may be adapted to supply pneumatic pressure to various features/components of the patient simulator 100. The features/components to which pneumatic pressure is supplied by the compressor(s) 210 may be contained in the simulated torso 115, the simulated head 105, the simulated right arm 120, the simulated left arm 125, the simulated right leg 130, and/or the simulated left leg 135. In some instances, the compressor(s) 210 may include a scroll compressor. In some instances, the compressor(s) 210 may supply pneumatic pressure to one or more of the reservoir(s) 220. In this regard, the reservoir(s) 220 may contain fluid and/or gas.

The control unit(s) 215 may be adapted to control the pump(s) 205, the compressor(s) 210, the reservoir(s) 220, including one or more valves associated with the pump(s), compressor(s), and/or reservoir(s), and/or various other features/components of the patient simulator 100. The features/components controlled by the control unit(s) 215 may be contained in the simulated torso 115, the simulated head 105, the simulated right arm 120, the simulated left arm 125, the simulated right leg 130, and/or the simulated left leg 135. In some instances, each of the control unit(s) 215 may be associated with one or more functions and/or features of the patient simulator 100.

The reservoir(s) 220 may contain fluid and/or gas for use in simulating one or more scenarios, functions, and/or features. For example, the reservoir(s) 220 may contain simulated bodily fluids (e.g., blood, urine, saliva, tears, etc.) and/or simulated bodily gasses (e.g., air, O₂, CO₂, etc.). The reservoir(s) 220 may include a single compartment or multiple compartments. The reservoir(s) 220 may be associated with one or more valves to control the flow of fluid and/or gas into and/or out of the reservoir(s) 220.

The power source(s) 225 may supply electrical power to the pump(s) 205, the compressor(s) 210, the control unit(s) 215, the reservoir(s) 220, including one or more valves associated with the pump(s), compressor(s), and/or reservoir(s), and various other features/components of the patient simulator 100. The features/components to which electrical power is supplied by the power source(s) 225 may be contained in the simulated torso 115, the simulated head 105, the simulated right arm 120, the simulated left arm 125, the simulated right leg 130, and/or the simulated left leg 135. The features/components to which electrical power is supplied by the power source(s) 225 may be contained in a different portion of the patient simulator 100 than the power source(s) 225. In some aspects, the power source(s) 225 includes lithium battery technology that reduces weight, volume, and complexity while providing greater power density. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc.

In some instances, the power source(s) 225 may be positioned within one or more extremities (e.g., the simulated right arm 120, the simulated left arm 125, the simulated right leg 130, and/or the simulated left leg 135) of the patient simulator 100. In this regard, an extremity containing the power source(s) 225 may be detachably coupled to the simulated torso 115. In some aspects, the extremity containing the power source(s) 225 may include a quick-connect connector to facilitate simple and/or fast power system changes (e.g., by swapping an extremity with a depleted power source for an extremity with a charged power source). In this regard, the quick-connect connector may physically couple the extremity to the simulated torso 115 and/or another aspect of the patient simulator 100 (e.g., upper and/or lower arm, upper and/or lower leg, etc.). The quick-connect connector may also electrically couple the power source(s) 225 contained in the extremity to one or more components of the patient simulator 100 (e.g., the pump(s) 205, the compressor(s) 210, the control unit(s) 215, the reservoir(s) 220, including one or more valves associated with the pump(s), compressor(s), and/or reservoir(s), and various other features/components). In some aspects, the quick-connect connector may also pneumatically and/or fluidly couple one or more components (e.g., pump(s) 205, compressor(s) 210, reservoir(s) 220, valve(s), and other pneumatic and/or fluid components) contained in the extremity (along with the power source(s) 225) to one or more other components of the patient simulator 100 (e.g., the pump(s) 205, the compressor(s) 210, the reservoir(s) 220, valve(s), and various other features/components).

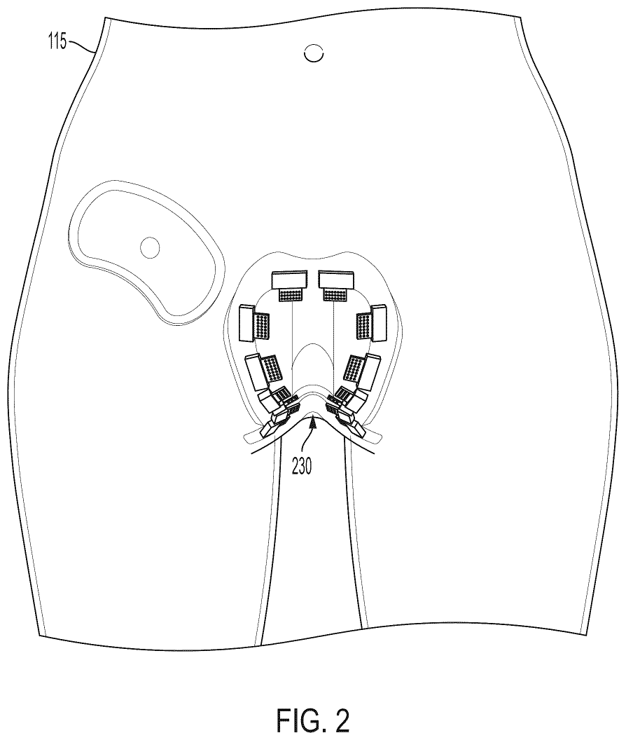

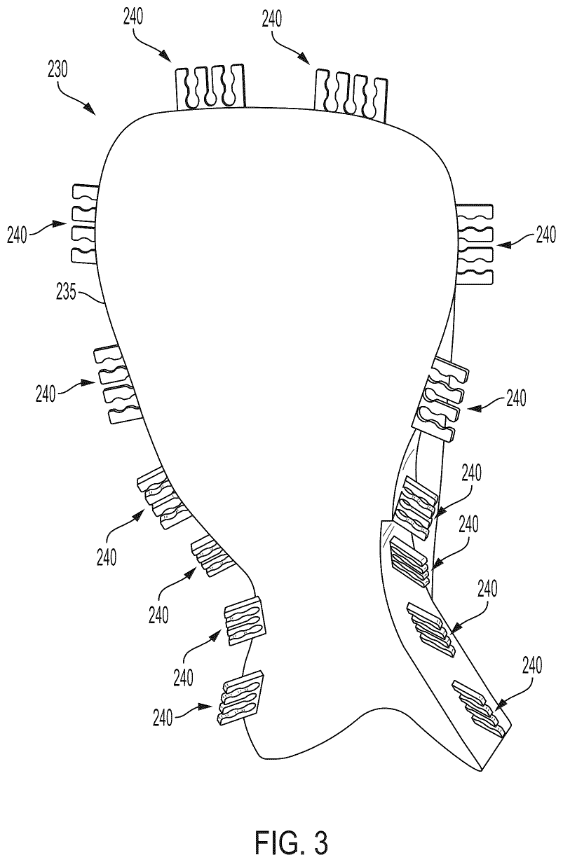

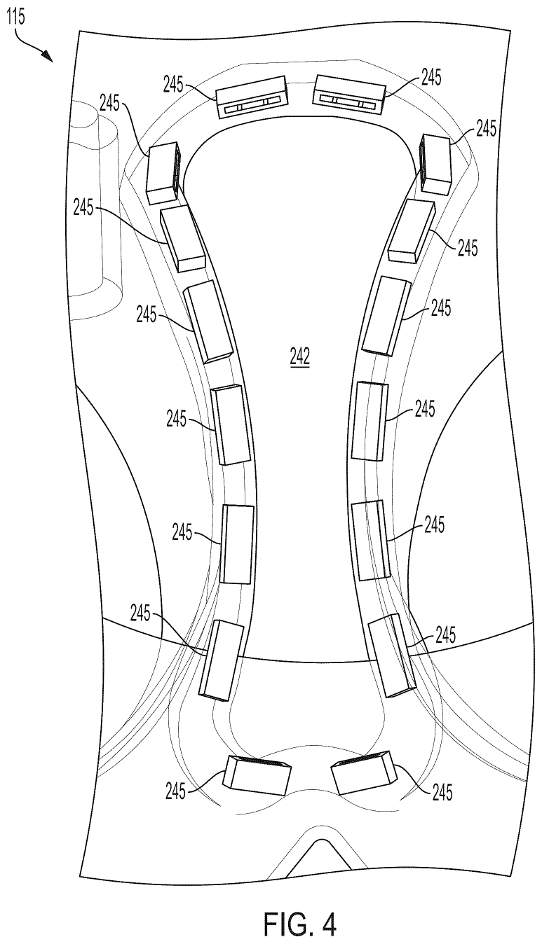

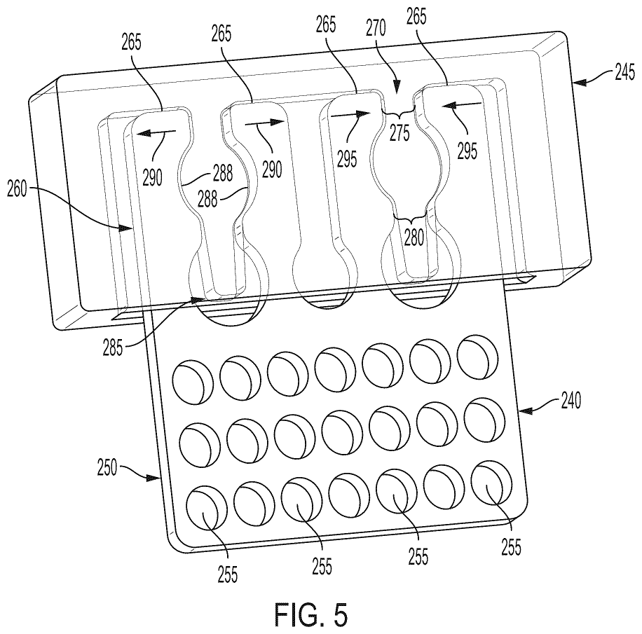

Referring to FIGS. 2-5 and continuing reference to FIG. 1, the patient simulator 100 includes one or more inserts 230 utilizing an insert connection system in accordance with the present disclosure. For example, FIG. 2 is a front view of the patient simulator 100 showing a vaginal insert 230 using an insert connection system, according to one or more aspects of the present disclosure. FIG. 3 is a perspective view of the vaginal insert 230 showing the male portion of the insert connection system, according to one or more aspects of the present disclosure. FIG. 4 is a front view of a portion of the torso 115 of the patient simulator 100 showing the female portion of the insert connection system, according to one or more aspects of the present disclosure. FIG. 5 is a perspective, phantom view of the male portion of the insert connection system engaged with the female portion of the insert connection system, according to one or more aspects of the present disclosure.

This vaginal inserts 230 of the present application utilize insert connection systems in accordance with the present disclosure. In this regard, the insert connection systems allow a single patient simulator (e.g., patient simulator 100) to provide realistic simulation of a plurality of different medical scenarios associated with the same portion of the simulator by allowing rapid, but secure interchanging of the inserts utilizing the associated connection systems. In some instances, a plurality of different vaginal (or other) inserts are provided that simulate different levels and/or types of trauma. Two or more inserts simulating various classification grades and/or different types of trauma may be provided and selectively interchanged using the insert connection system that is common to all the inserts. In this regard, while some of the examples provided herein are related to vaginal inserts, it is understood that the insert connection systems of the present disclosure may be used in a variety of other situations and areas of the patient simulator, including for inserts associated areas having variable and/or inconsistent skin profiles.

Referring to FIGS. 2-5, the torso 115 of the patient simulator 100 may be configured to receive a vaginal insert 230. As shown in FIG. 3, the vaginal insert 230 may include a skin portion 235 and a plurality of male connectors 240 associated with the insert connection system. As shown in FIG. 4, the torso 115 of the patient simulator 100 may include an opening 242 sized and shaped to receive the vaginal insert 230. In this regard, the torso 115 may include a plurality of female connectors 245 associated with the insert connection system. The plurality of female connectors 245 are positioned and sized and shaped to engage with the plurality of male connectors 240 of the vaginal insert 230 to couple the vaginal insert 230 to the torso 115 of the patient simulator 100. The arrangement of the plurality of female connectors 245 and the plurality of male connectors 240 and the nature of the connection between each female connector 245 and each male connector 240 allows the variable and/or inconsistent skin profile(s) associated with the vaginal insert 230 to present as intended without unwanted creasing, bends, or other material deformities that may detract from the realism of the simulation.

Referring more specifically to FIG. 5, a male connector 240 of the insert connection system is engaged with a female connector 245 of the insert connection system in accordance with some aspects of the present disclosure. As shown, the male connector 240 includes an anchoring portion 250 having a plurality of openings 255. In this regard, the anchoring portion 250 may be configured to anchored a skin portion or other layer of vaginal (or other) insert 230. For example, one or more layers of the vaginal insert 230 may be formed or molded around the anchoring portion 250 such that the associated material extends through and/or around the plurality of openings 255, thereby securing male connector 240 to the vaginal insert 230. The male connector 240 also includes an engagement portion 260 that is configured to interface and removably engage with the female connector 245 of the insert connection system. As shown, the engagement portion 260 includes two pairs of arms 265, though any suitable number of arms and/or pairs of arms may be utilized. In this regard, each pair of arms 265 defines an opening 270. The opening 270 may have a generally oval shape (when viewed from above) such that the narrowest parts of the opening 270 are defined between end portions 275 and narrowings 280. In this regard, each pair of arms 265 are configured to engage an associated projection 285 of the female connector 245. The associated projection 285 may be within a slot, opening, or recess of the female connector 245, as shown. In this regard, the pair of arms 265 are configured to expand around a bulbous portion 288 of the projection 285 (as indicated by arrows 290) as the male connector 240 is inserted into the female connector 245 and then contract or claim around the bulbous portion 288 (as indicated by arrows 295) as the end portions 275 pass the bulbous portion 288. In this regard, the male connector 240 may be formed or a resiliently flexible material to facilitate numerous engagements and disengagements with the female connector 245 without causing damage to the male connector. Accordingly, in some aspects the male connector 240 may be formed of a flexible plastic (e.g., polyoxymethylene), silicon, rubber, polymer, or other suitable material. On the other hand, the female connector 245 may be formed of a more rigid material, such as a hard or rigid plastic, PVC, metal, silicon, rubber, polymer, or other suitable material. In some aspects, the female connector 245 is secured to a skin portion or support structure of the torso 115 of the patient simulator. For example, one or more tissue layers of the torso may be formed or molded around the female connectors 245. In other instances, the female connectors 245 may be mechanically and/or chemically connected or anchored in place within the torso 115 of the patient simulator 100.

In this manner, the male connectors 240 and the female connectors 245 of the insert connection system may be utilized to quickly swap different inserts for use with the patient simulator 100, including vaginal inserts ranging from healthy to varying degrees and/or types of injury, trauma, and/or disease. Further, the integration of the male connectors 240 within the vaginal insert 230 (or within the torso 115 of the patient simulator 100) and integration of the female connectors 245 within the torso 115 of the patient simulator 100 (or within the vaginal insert 230) allows the skin layers of the vaginal insert 230 and the torso 115 to be aligned to provide a smooth and/or seamless transition between the insert and the patient simulator regardless of which of variety of inserts may be utilized at any given time.

As described above, the connection systems of the present disclosure facilitate connecting inserts to patient simulators, enhancing their versatility and efficiency in medical training. The insert connection systems allow a single patient simulator to be used for various medical scenarios by enabling the rapid and secure interchange of different inserts. This capability means that different types and levels of trauma can be simulated using the simulator, making it a highly adaptable and versatile tool for training purposes. By simply changing inserts, the simulator can replicate a wide range of medical conditions or traumas, making it useful for diverse training scenarios. Additionally, the efficiency of the system is notable, as inserts can be swapped out quickly, saving valuable time during training sessions. The realism provided by the different inserts, which can simulate various levels and types of trauma, offers trainees a more authentic experience. Furthermore, the secure connection system ensures that the inserts remain firmly attached, preventing them from coming loose during use. While the examples provided include vaginal inserts, the system is versatile enough to be used for other body parts with varying skin profiles. Overall, the insert connection systems enhance the functionality and realism of patient simulators, making them more effective tools for medical training.

The present application further includes the following aspects:
1. A patient simulator, comprising:
   a simulated portion of a human body; and
   an insert configured to be selectively coupled to the simulated portion of the human body via an insert connection system, wherein one of the simulated portion of the human body or the insert includes a plurality of male connectors of the insert connection system and the other of the simulated portion of the human body or the insert includes a plurality of female connectors of the insertion connection system, wherein each male connector includes at least one pair of opposing arms and each female connector includes a projection and the at least one pair of opposing arms of the male connector is configured to releasably engage with the projection of the female connector.
2. The patient simulator of aspect 1, wherein the at least one pair of opposing arms define an opening having an oval shape configured to mate with an outer profile of the projection of each female connector.
3. The patient simulator of aspect 2, wherein the at least one pair of opposing arms is configured to expand around the projection of each female connector as the male connector is inserted into the female connector.
4. The patient simulator of any of aspects 1-3, wherein each male connector includes at least two pairs of opposing arms and each female connector includes at least two projections.
5. The patient simulator of any of aspects 1-4, wherein the male connector is formed of a first material and the female connector is formed of a second material different than the first material.
6. The patient simulator of aspect 5, wherein the first material is more flexible than the second material.
7. The patient simulator of aspect 6, wherein the insert includes the plurality of male connectors.
8. The patient simulator of any of aspects 1-7, wherein the plurality of male connectors are attached to the insert by engagement of one or more layers of the insert with an anchor portion of each of the plurality of male connectors.
9. The patient simulator of aspect 8, wherein the anchor portion includes a plurality of openings through which material of the one or more layers of the insert extends through.
10. The patient simulator of any of aspects 1-9, further comprising:
   one or more replacement inserts, each of the one or more replacement inserts configured to be selectively coupled to the simulated portion of the human body via the insert connection system.
11. The patient simulator of aspect 10, wherein one or more replacement inserts simulate a different level and/or type of trauma than the insert.
12. The patient simulator of any of aspects 1-11, wherein the insert comprises a simulated skin layer.
13. The patient simulator of aspect 12, wherein the insert comprises a vaginal insert.
14. An insert connection system for patient simulators, the insert connection system comprising:
   a plurality of male connectors configured to be coupled to an insert; and
   a plurality of female connectors configured to be coupled to a patient simulator;
wherein:
   each male connector of the plurality of male connectors includes at least one pair of opposing arms;
   each female connector of the plurality of female connectors includes a projection; and
   the at least one pair of opposing arms of each male connector of plurality of male connectors is configured to releasably engage with the projection of each female connector of the plurality of female connectors.
15. The insert connection system of aspect 14, wherein the at least one pair of opposing arms is configured to expand around the projection of the female connector as the male connector is inserted into the female connector, the at least one pair of opposing arms defining an opening having an oval shape configured to mate with an outer profile of the projection of each female connector.
16. The insert connection system of any of aspects 14-15, wherein each male connector includes at least two pairs of opposing arms and each female connector includes at least two projections.
17. The insert connection system of any of aspects 14-16, wherein the male connector is formed of a first material and the female connector is formed of a second material different than the first material, the first material being more flexible than the second material.
18. The insert connection system of any of aspects 14-17, wherein the plurality of male connectors include an anchor portion having a plurality of openings configured to engage with material of one or more layers of the insert.
19. A method, comprising:
   coupling a first insert to a simulated portion of a human body using an insert connection system by engaging a plurality of male connectors coupled to the insert with a plurality of female connectors coupled to the simulated portion of the human body, wherein each male connector includes at least one pair of opposing arms and each female connector includes a projection;
   decoupling the first insert from the simulated portion of a human body by disengaging the plurality of male connectors from the plurality of female connectors; and
   coupling a second insert to the simulated portion of the human body using the insert connection system by engaging a plurality of male connectors coupled to the second insert with the plurality of female connectors coupled to the simulated portion of the human body.
20. The method of aspect 19, wherein the second insert simulates a different level and/or type of trauma than the first insert.
21. The method of any of aspects 19-20, wherein the at least one pair of opposing arms define an opening having an oval shape configured to mate with an outer profile of the projection of each female connector.
22. The method of aspect 21, wherein the at least one pair of opposing arms is configured to expand around the projection of each female connector as the male connector is inserted into the female connector.
23. The method of any of aspects 19-22, wherein each male connector includes at least two pairs of opposing arms and each female connector includes at least two projections.
24. The method of any of aspects 19-23, wherein the male connector is formed of a first material and the female connector is formed of a second material different than the first material.
25. The method of aspect 24, wherein the first material is more flexible than the second material.
26. The method of any of aspects 19-25, wherein the plurality of male connectors are attached to the insert by engagement of one or more layers of the insert with an anchor portion of each of the plurality of male connectors.
27. The method of aspect 26, wherein the anchor portion includes a plurality of openings through which material of the one or more layers of the insert extends through.
28. The method of any of aspects 19-27, further comprising:
   selecting the second insert from a plurality of replacement inserts, each of the plurality of replacement inserts configured to be selectively coupled to the simulated portion of the human body via the insert connection system.

29. The method of aspect 28, wherein each of plurality of replacement inserts simulates a different level and/or type of trauma.

30. The method of any of aspects 19-29, wherein the insert comprises a simulated skin layer.

31. The method of any of aspects 19-30, wherein the insert comprises a vaginal insert.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

1. A patient simulator, comprising:
a simulated portion of a human body; and
an insert configured to be selectively coupled to the simulated portion of the human body via an insert connection system, wherein one of the simulated portion of the human body or the insert includes a plurality of male connectors of the insert connection system and the other of the simulated portion of the human body or the insert includes a plurality of female connectors of the insertion connection system, wherein each male connector includes at least one pair of opposing arms and each female connector includes a projection and the at least one pair of opposing arms of the male connector is configured to releasably engage with the projection of the female connector.

2. The patient simulator of claim 1, wherein the at least one pair of opposing arms define an opening having an oval shape configured to mate with an outer profile of the projection of each female connector.

3. The patient simulator of claim 2, wherein the at least one pair of opposing arms is configured to expand around the projection of each female connector as the male connector is inserted into the female connector.

4. The patient simulator of claim 1, wherein each male connector includes at least two pairs of opposing arms and each female connector includes at least two projections.

5. The patient simulator of claim 1, wherein the male connector is formed of a first material and the female connector is formed of a second material different than the first material.

6. The patient simulator of claim 5, wherein the first material is more flexible than the second material.

7. The patient simulator of claim 6, wherein the insert includes the plurality of male connectors.

8. The patient simulator of claim 7, wherein the plurality of male connectors are attached to the insert by engagement of one or more layers of the insert with an anchor portion of each of the plurality of male connectors.

9. The patient simulator of claim 8, wherein the anchor portion includes a plurality of openings through which material of the one or more layers of the insert extends through.

10. The patient simulator of claim 1, further comprising:
one or more replacement inserts, each of the one or more replacement inserts configured to be selectively coupled to the simulated portion of the human body via the insert connection system.

11. The patient simulator of claim 10, wherein one or more replacement inserts simulate a different level and/or type of trauma than the insert.

12. The patient simulator of claim 1, wherein the insert comprises a simulated skin layer.

13. The patient simulator of claim 12, wherein the insert comprises a vaginal insert.

14. An insert connection system for patient simulators, the insert connection system comprising:
a plurality of male connectors configured to be coupled to an insert; and
a plurality of female connectors configured to be coupled to a patient simulator;
wherein:
each male connector of the plurality of male connectors includes at least one pair of opposing arms;
each female connector of the plurality of female connectors includes a projection; and
the at least one pair of opposing arms of each male connector of plurality of male connectors is configured to releasably engage with the projection of each female connector of the plurality of female connectors.

15. The insert connection system of claim 14, wherein the at least one pair of opposing arms is configured to expand around the projection of the female connector as the male connector is inserted into the female connector, the at least one pair of opposing arms defining an opening having an oval shape configured to mate with an outer profile of the projection of each female connector.

16. The insert connection system of claim 14, wherein each male connector includes at least two pairs of opposing arms and each female connector includes at least two projections.

17. The insert connection system of claim 14, wherein the male connector is formed of a first material and the female connector is formed of a second material different than the first material, the first material being more flexible than the second material.

18. The insert connection system of claim 14, wherein the plurality of male connectors include an anchor portion having a plurality of openings configured to engage with material of one or more layers of the insert.

19. A method, comprising:
coupling a first insert to a simulated portion of a human body using an insert connection system by engaging a plurality of male connectors coupled to the first insert with a plurality of female connectors coupled to the simulated portion of the human body, wherein each male connector includes at least one pair of opposing arms and each female connector includes a projection;
decoupling the first insert from the simulated portion of a human body by disengaging the plurality of male connectors from the plurality of female connectors; and
coupling a second insert to the simulated portion of the human body using the insert connection system by engaging a plurality of male connectors coupled to the second insert with the plurality of female connectors coupled to the simulated portion of the human body.

20. The method of claim 19, wherein the second insert simulates a different level and/or type of trauma than the first insert.
